(19) United States
(12) Patent Application Publication
(10) Pub. No.: US 2019/0330861 A1
(43) Pub. Date: Oct. 31, 2019

(54) System and Process for Air Sealing Penetrations in a Building

(71) Applicant: Terry Nordbye, Point Reyes, CA (US)

(72) Inventor: Terry Nordbye, Point Reyes, CA (US)

(21) Appl. No.: 15/964,510

(22) Filed: Apr. 27, 2018

(51) Int. Cl. E04F 21/12; B05B 7/14

(52) U.S. Cl. CPC E04F 21/12; B05B 7/2416; B05B 7/1436

(57) ABSTRACT

A process for air sealing penetrations in a building which includes locating a group of penetrations and covering the penetrations with an air sealing material.

### CROSS-REFERENCE TO RELATED APPLICATION

This application claims the benefit of U. S. Provisional Patent Application No. 62/231,582, filed Jul. 10, 2015 and titled “Air Sealing Compound”, the entire disclosure of which is incorporated by reference herein for all purposes.

### FIELD

This patent specification relates to systems and processes for sealing air leaks in buildings.

### BACKGROUND OF THE INVENTION

Most commercial and residential buildings include systems to condition the air inside the building by heating or cooling or both. The U. S. Department of Energy advises homeowners that they can reduce the energy consumption of their homes by reducing the movement of air between so-called conditioned space inside the building and unconditioned space, which can be inside parts of the building which are not insulated or adjacent to the building. In their publication titled “Retrofit Techniques & Technologies: Air Sealing—A Guide for Contractors to Share with Homeowners” the U.S. Department of Energy describes the problem as follows: “Imagine opening a window in your house and leaving it that way 24 hours a day, all year long. On balmy spring days, the breeze wouldn't be so bad. But, in the freezing cold of winter and the sticky heat of summer, with the furnace or air conditioner on, smart homeowners would recognize they might as well be throwing buckets of quarters out the window to pay for the escaping heated or cooled air.”

It is therefore desirable to provide systems and processes for air sealing of buildings by sealing penetrations which allow air to leak into or from conditioned space inside the building. Additionally it is desirable to provide air sealing systems and processes which can be accomplished with minimum labor and time while being effective in reducing air leakage to the maximum extent possible.

It is an object of the present invention to provide improved systems and methods for air sealing of buildings.

### BRIEF SUMMARY OF THE INVENTION

This and other objects of the invention are accomplished in accordance with the principles of the present invention by providing systems and processes for air sealing a building by spraying an air sealing material using pressurized air or a brush.

An embodiment of a system for applying air sealing material may include a spray gun connected to an air compressor and to a pump that in turn is connected to a reservoir which contains sealing material. An operator of the system may spray sealing material onto a penetration or group of penetrations to seal them.

According to another embodiment an operator may use a brush instead of a spray gun to apply sealing material to the penetration or group of penetrations to seal them.

According to some embodiments the sealing material includes an elastomeric compound mixed with a granular material such as polystyrene or cork.

### BRIEF DESCRIPTION OF THE DRAWINGS

FIG. 1 is an illustration of the upper story of a house, which exemplifies a conditioned space, and an uninsulated attic, which exemplifies an unconditioned space.

FIG. 2 is an illustration the lower portion of an attic with representative equipment and features.

FIG. 3 is a block diagram illustrating a process according to an embodiment of the invention.

FIG. 4 is a cross section showing an exemplary electrical junction box with air sealing material applied.

### DETAILED DESCRIPTION OF THE INVENTION

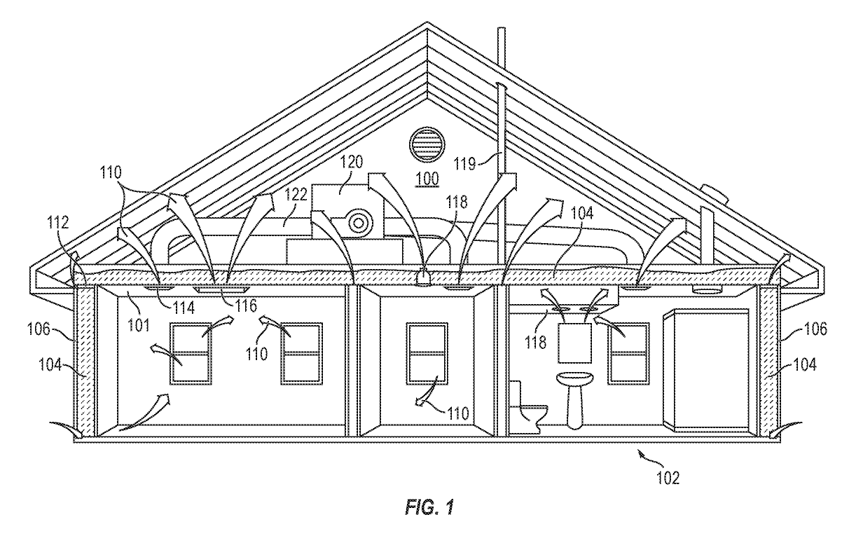

FIG. 1 shows the upper two stories of an illustrative building which in this case is a residential structure. An attic 100 is located above the ceiling 101 of the upper story 102 which includes walls 106. Additional stories are located below the upper story 102 but are not shown for simplicity. Insulating material 104 surrounds the upper story 102 and the stories below it so that the upper story and stories below it are considered to be conditioned space. On the other hand, the floor of the attic 100 includes insulation 104 but the remainder of the attic 100 is not insulated and therefore the attic is considered unconditioned space.

Buildings often include many penetrations or holes whereby air can leak between conditioned and unconditioned space. In the example shown in FIG. 1 some examples of air leakage are schematically illustrated by arrows 110. For example, air leakage into the upper story 102 can occur e.g. as indicated by arrows 110 at windows and around walls. Air can leak from the upper story 102 into the attic 100 e.g. as schematically illustrated by arrows 110 through penetrations located at top plates 112, duct registers 114, attic hatch 116, light fixtures 118 and plumbing vent stack 119. A system for heating, ventilation and air conditioning (HVAC system) 120 supplies heated and cooled air to the upper story 102 through ducts 122 and duct registers 114.

To seal the penetrations an air sealing system which includes a spraying system is used. I have found that a conventional texture spraying system can be used for this purpose. Texture spraying systems are taught for example in U.S. Pat. No. 7,980,487 titled “Texture Sprayer”, U.S. Pat. No. 9,138,762 titled “Texture Spray Gun” and in U.S. Pat. No. 8,210,449 titled “Texture Sprayer,” and the disclosures of these patents are incorporated herein by reference. Texture spraying systems are well known in the art of residential and commercial construction, and systems that I have found to work well for the application of air sealing material are TexSpray Models RTX 1250 and RTX 1500 both manufactured by Graco Corporation. Texture spray systems generally include a compressor to provide pressurized air and a container and pump system to store the texture material and deliver it to a spray gun. An operator uses the spray gun to combine a stream of pressurized air with the texture material and disperse the texture material and to spray the dispersed material onto a surface.

In some cases as an alternative to spraying the sealing material to seal penetrations an operator can use a brush to apply the sealing material.

The sealing material includes an elastomeric component mixed with a solid component. The elastomeric component can be a water-based acrylic material which is in fluid form while it is wet and forms a solid and flexible material when cured and dry. The elastomeric component has strong adhesive qualities both when wet and when it is dry. Preferably the elastomeric component is product number AB 7000 manufactured by Western Colloid Corporation which is a latex elastomeric. A suitable alternative in some cases can be other elastomeric compounds such as that manufactured by Western Colloid Corporation and sold as #298E Elastomeric Asphalt Emulsion.

The solid component can be particles of expanded styrene polymer (EPS) manufactured by Insulfoam of Dixon California. The EPS particles are made by grinding up old EPS sheets and blocks at the Insulfoam factory. The particles are of a size to pass through a 3/16^{th} inch screen. The size of the EPS particles may range from 20 to 120 mils (0.508 to 3.048 millimeters) and the largest particles can be about ¼ inch in diameter. I have found that particles about ⅛ inch in diameter is preferred.

I have found that a mixture of solid and elastomeric components in a ratio by volume of between about two to four parts solid to about one part elastomer and more preferably about three parts solid to one part elastomer yields good results.

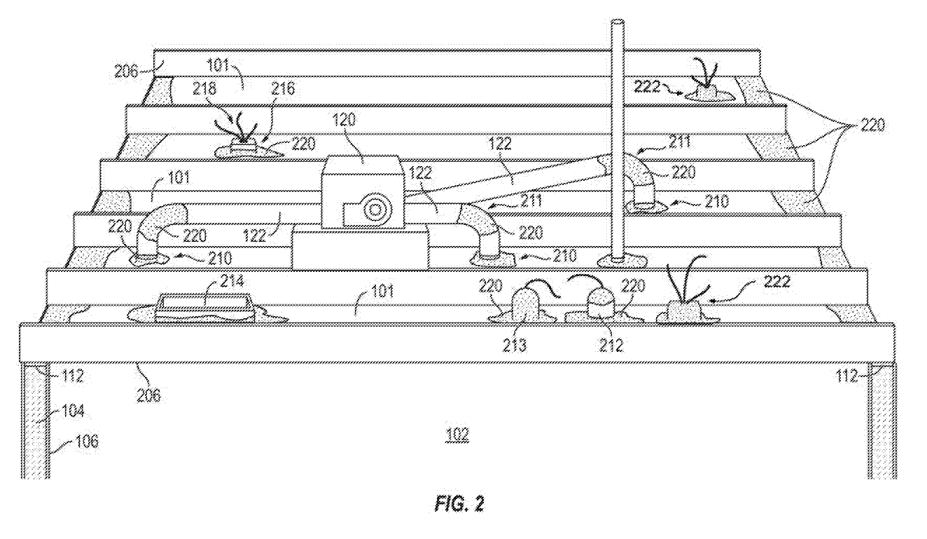

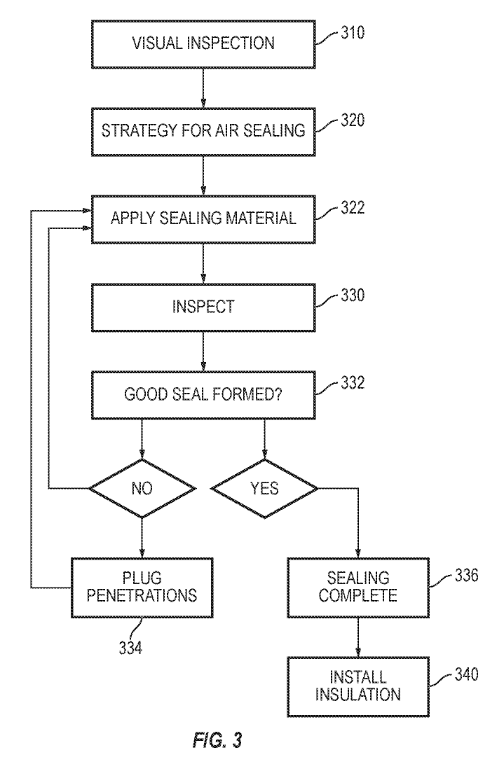

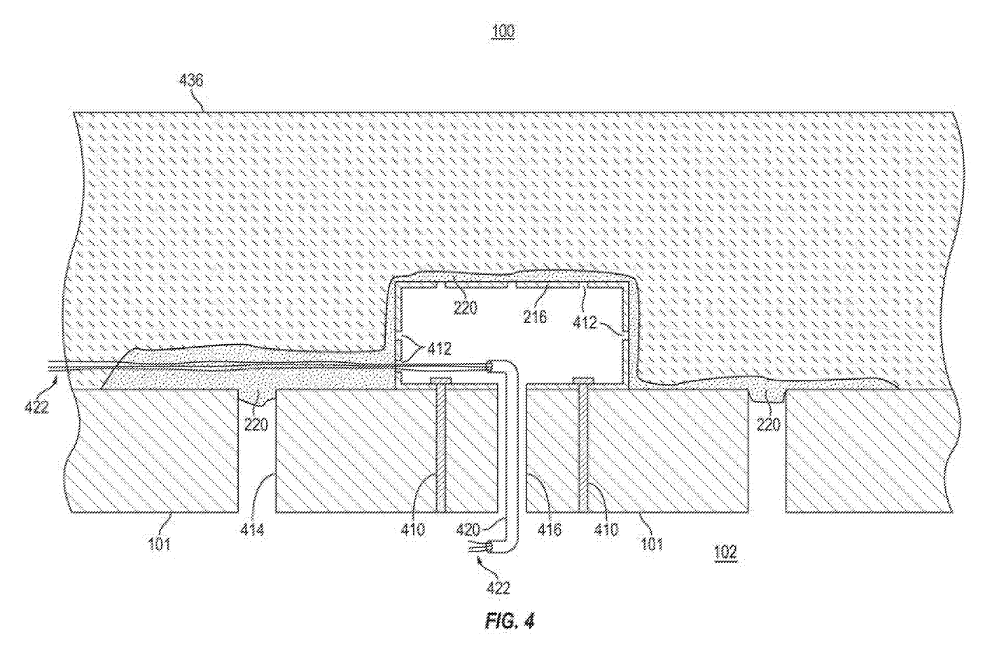

Turning to FIG. 2, FIG. 3 and FIG. 4 the process of sealing penetrations can now be understood. An operator initially conducts a visual inspection of the area to be sealed which for this example can be an attic 100 such as shown in FIG. 1. Although FIG. 1 shows relatively few penetrations, in practice there may be many penetrations in an area such as an attic, and the penetrations may be scattered in various locations and in some cases clustered. Some penetrations can be small and some relatively large.

FIG. 2 is a schematic illustration of the lower part of an attic, and the attic is located above the ceiling 101 of the upper story 102. The ceiling 101 of the story 102 and the ceiling joists 206 are shown. Top plates 112 extend along the tops of walls 106. Penetrations in the ceiling 101 are shown with air sealing material 220 applied. The sealed fixtures shown are sealed duct registers 210, sealed light fixtures 212 and 213, sealed attic hatch 214, and sealed electrical junction boxes 216 and 222. The light fixtures 212 and 213 include electrical wiring 218, and the wiring 218 passes through penetrations as it enters the fixtures 212 and 213. In the case of fixture 212 a blanket of sealing material 220 is shown as applied in two sections, one section around the penetration associated with the wiring and another associated with the penetration at the junction of the fixture 212 and the ceiling 101. In the case of fixture 213 the sealing material 220 is shown as applied in a single blanket 220 which seals the penetration associated with the wiring as well as the penetration at the junction of the fixture 212 and the ceiling 101. In the case of electrical junction box 216 a blanket of sealing material 220 is shown applied to seal penetrations where the junction box meets the ceiling 101 but not where the electrical wiring 218 enters the junction box 216 since the electrical wiring is already well sealed by the manufacturer of the junction box. In the case of electrical junction boxes 222 a blanket of sealing material 220 is shown applied to seal penetrations where the junction boxes meets the ceiling 101 as well as where the electrical wiring 218 enters the junction boxes 222. Penetrations are located at the ends of the ceiling boards where the ceiling 101 meets the wall 106 and top plates 112 are sealed with blankets of sealing material 220. If not sealed these penetrations can allow the passage of air from the conditioned space of story 102 to the unconditioned space of the attic 100.

Turning now to the HVAC system 120 and ducts 122, the ducts 122 convey conditioned air between the HVAC system 120 and areas within the building so that the interior of the ducts is conditioned space and penetrations in the ducts allow leakage of conditioned air from the ducts to unconditioned space or leakage of unconditioned air to conditioned space within the ducts. Penetrations in the ducts 122 are shown sealed in various types of locations, at the duct registers 210, at joints 211 with the registers 210 and at bends 213. The duct registers are installed in the ceiling 101 and penetrations can be present at the juncture of the duct registers and the ceiling as well as elsewhere in the duct registers 210. The ducts 122 are formed of sheet metal and therefore there can be leaks at various locations such as their joints with other metal fixtures such as the registers 210 and at bends 211 as well as at transitions such as where the ducts 122 are attached to the HVAC system 120. As illustrated, blankets of sealing material 220 are placed at these locations.

It should be understood that the penetrations which exist in practice in a normal building are too numerous to show in detail herein, and the location and nature of penetrations can be somewhat different in each structure. For example, electrical junction boxes such as those represented schematically as junction boxes 216 have many different designs and can include many small holes. Moreover, the wiring that enters and leaves a junction box may not fit snugly into holes in the box thereby resulting in penetrations that have irregular shapes and which allow air leaks. Similarly, light fixtures have many designs and often light fixtures can result in air leakage pathways. For example, some light fixtures can include many small holes where wiring enters the fixture and elsewhere, and often when a light fixture is installed in a ceiling there are gaps around the fixture.

Another significant penetration for air leakage in many buildings can be found at top plates such as those indicated schematically by top plates 112. Air in conditioned space can flow into walls through many pathways such as electrical fixtures and through spaces around walls. The air can travel upward and through spaces around the top plates 112 and into the attic 100.

Moreover, in a normal building there may be many other types and configurations of penetrations beyond those schematically illustrated in FIG. 2.

Referring now to FIG. 3 a method is illustrated for air sealing penetrations. At block 310 an operator conducts a visual inspection of the area to be air sealed. In this example the area to be sealed is an attic. The step of visual inspection 310 includes locating penetrations that permit air leakage. If there is existing insulation such as fiberglass or blown cellulose on the upper side of the ceiling of the story below the attic the insulation would normally preclude visual inspection of the ceiling for penetrations into the attic. In such case the step of visual inspection 310 would include removal of existing insulation.

At block 320 the operator develops a strategy for applying air sealing material. The strategy includes identification of groups of penetrations that the operator plans to seal as separate groups and an assessment of the quantity of air sealing material necessary to provide a good seal. At block 322 the operator applies air sealing material to each group of penetrations. To apply the sealing material the operator aims the spray gun toward the penetration or group of penetrations and pulls the trigger of the gun. This causes a stream of pressurized air and a stream of sealing material to flow into the gun and mix in the gun so that the pressurized air atomizes the sealing material and directs a generally conical spray of sealing material mixed with air toward the penetrations. This results in a roughly circular pattern of sealing material being deposited on the penetrations and the solid material adjacent the penetrations. The size of the circle varies depending on a number of factors including the distance between the spray gun and the penetrations, but in practice I found it good practice to locate the spray gun roughly one to two feet from the penetrations which results in a spray of about six inches to one foot in diameter at the penetrations.

As the operator sprays the sealing material it builds up on the solid surfaces while covering some or all of the penetrations and filling some of the penetrations at least partially. The sealing material is strongly adhesive and readily adheres to the solid surfaces. The sealing material is also strongly cohesive and readily fills penetrations and covers the penetrations. Smaller penetrations are sealed quickly and with little sealing material being required while larger penetrations may not be sealed or may be partially sealed. Depending on how long the operator directs the spray toward a particular area the operator can control the volume of sealing material deposited and the thickness of the deposited material. I have found it preferable to apply sealing material to produce a blanket about 1/16 (one sixteenth) inch in thickness.

Generally speaking, although penetrations are three dimensional, only two dimensions are of primary significance in the sealing process. Specifically, the length and the width in directions generally perpendicular to the direction at which the sealing material is sprayed, are most important while the depth is less so. I have found that penetrations which are large in two dimensions may be more difficult to seal than are penetrations which are small in one dimension and large in the other, and penetrations which are easiest to seal are small in both dimensions. I have found that my system is capable of sealing penetrations having a maximum diameter of about ⅜ (three eighths) inch.

In some cases an operator may employ an experimental approach to the step of sealing. This is illustrated by blocks 322, 330 and 332. The operator may apply one layer of sealing material and then inspect the area to determine whether a good seal has been formed. If a good seal has not been formed and some unsealed penetrations remain then the operator will apply another layer and re-inspect. If a good seal has still not been formed then another pass may be necessary. If a good seal has still not been formed the operator may plug incompletely sealed penetrations with a solid material (block 334) and then apply more air sealing material. After a good seal has been formed the process can be considered complete, block 336. Optionally, according to block 340 insulation such as fiberglass bats or cellulose can be installed over the sealing material and the remainder of the lower parts of the attic.

FIG. 4 is a schematic illustration of cross sectional view of an electrical junction box with wiring. As shown the electrical junction box 216 is attached by two bolts 410 to the ceiling 101 and the ceiling includes penetrations 414 and 416. The ceiling penetration 416 below the junction box 216 is provided to permit a electrical cable 420 to pass between the top story 102 and the attic 100. The electrical junction box 216 includes multiple penetrations or holes 412 which, if not sealed, allow air to flow between the attic 100 and the top story 102. Moreover, in some circumstances air can flow via pathways not illustrated in FIG. 4. For example, the bottom of an electrical junction box may not form an air tight seal with a ceiling and therefore air can flow between the bottom of the box and the ceiling.

The electrical cable 420 includes three wires 422 which are separate and not housed in the electrical cable 420 as they leave the electrical junction box 216 through penetration 412. The illustrated junction box 216 and electrical cable 420 are merely exemplary, and in practice electrical junction boxes and electrical cables can have many different configurations.

To air seal the electrical junction box 216 and related wires and penetrations an operator applies sealing material to form a blanket 220 which covers and adheres to the junction box 216 as well as the area surrounding the junction box 216 including top surfaces of the ceiling 101 near the junction box 216 and wires 422. The blanket of sealing material 220 may fill or partially fill some or all of the penetrations 412 in the junction box 216 and penetrations 414 in the ceiling. The blanket of sealing material 220 also can surround each of the wires 422 and fill the spaces around the wires 422 to provide an air seal. In practice I have found that an effective air seal can be provided by creating a blanket of air sealing material 220 which extends at least about one inch beyond any penetrations.

After the blanket 220 has been created and allowed to cure, conventional thermal insulation 436 such as fiberglass or cellulose can be placed on top of the blanket 220 and the upper faces of the ceiling 101.

1. A process for air sealing penetrations in a building, the process comprising:
a) locating a group of penetrations which are spaced apart from each other and are separated from each other by surfaces of solid material; and,
b) covering the penetrations and surfaces of the solid material between the penetrations with an air sealing material by spraying the air sealing material onto the penetrations and the surfaces using a spraying system;
c) wherein the spraying system combines a stream of pressurized air with the air sealing material and disperses the air sealing material in the air.

2. (canceled)

3. (canceled)

4. A process according to claim 1 wherein the air sealing material comprises an elastomer.

5. A process according to claim 4 wherein the air sealing material comprises an elastomeric component and a solid component wherein when applied the elastomeric component is in a fluid condition and thereafter the elastomeric component cures due to contact with the air.

6. A process according to claim 5 wherein the elastomeric component comprises water and curing includes release of water to the atmosphere.

7. A process according to claim 1 wherein the air sealing material comprises solid granules and an elastomer.

8. (canceled)

9. A process according to claim 7 wherein the solid granules have a diameter of about ⅛ inch.

10. A process according to claim 7 wherein the solid granules comprise polystyrene.

11. A process according to claim 7 wherein the ratio by volume of elastomeric component to solid component is about 1:3.

12. A process according to claim 7 wherein the solid granules are cork.

13. (canceled)

14. (canceled)

15. A process according to claim 1 wherein the penetrations are located in an HVAC duct.

16. (canceled)

17. (canceled)

18. (canceled)

19. A process according to claim 1 wherein said spraying system includes a compressor system to pressurize air and deliver the pressurized air to a spray gun.

20. A process according to claim 19 wherein said spraying system includes a container system to contain air sealing material and to deliver the air sealing material to the spray gun.

21. A process according to claim 1 wherein said spraying system includes a texture sprayer.

22. A process for air sealing penetrations in a building, the process comprising:
a) locating a group of penetrations which are spaced apart from each other and are separated from each other by surfaces of solid material;
b) covering the penetrations and surfaces of the solid material between the penetrations with an air sealing material;
c) thereafter visually inspecting the covered penetrations to determine whether a good air seal has been formed; and,
d) if a good air seal has not been formed then applying a second coat of the air sealing material.

23. A process according to claim 22 further including:
a) covering the penetrations and surfaces of the solid material between the penetrations with a controlled thickness of air sealing material by spraying the air sealing material toward the penetrations for a controlled time.

24. A process according to claim 23 wherein the controlled thickness is about one sixteenth inch.

25. A process according to claim 22 further including:
a) following the step of applying the second coat of the air sealing material, visually inspecting the covered penetrations to determine whether a good air seal has been formed: and,
b) if a good air seal has not been formed then applying a third coat of the air sealing material.

26. A process for air sealing penetrations in a building, the process comprising:
a) locating a group of penetrations which are spaced apart from each other and are separated from each other by surfaces of solid material;
b) identifying any large penetrations in the group of penetrations;
c) plugging large penetrations with solid plug material; and,
b) covering the penetrations, the solid plug material and surfaces of the solid material between the penetrations with an air sealing material by spraying the air sealing material onto the penetrations, solid plug material and the surfaces.
